(19) United States
(12) Patent Application Publication
(10) Pub. No.: US 2026/0237873 A1
(43) Pub. Date: Aug. 13, 2026

(54) SECONDARY BATTERY

(71) Applicants: TOYOTA JIDOSHA KABUSHIKI KAISHA, Toyota-shi (JP); Prime Planet Energy & Solutions, Inc., Tokyo (JP)

(72) Inventors: Masato ONO, Nagoya-shi (JP); Norihiro OSE, Nagoya-shi (JP); Yasuhiro SAKASHITA, Nisshin-shi (JP); Koichi YANASE, Nagoya-shi (JP); Takeru HARA, Toyota-shi (JP); Yuka YOKOI, Nagoya-shi (JP); Kohji UMEMURA, Ono-shi (JP); Toshiki IMABORI, Kasai-shi (JP); Yoshinori HIRANO, Nagoya-shi (JP); Satoshi FUJIMURA, Toki-shi (JP)

(73) Assignees: TOYOTA JIDOSHA KABUSHIKI KAISHA, Toyota-shi (JP); Prime Planet Energy & Solutions, Inc., Tokyo (JP)

(21) Appl. No.: 19/438,939

(22) Filed: Jan. 2, 2026

(30) Foreign Application Priority Data
Feb. 7, 2025 (JP) 2025-018891

(51) Int. Cl. H01M 50/591; H01M 10/0587; H01M 50/103

(52) U.S. Cl. CPC H01M 50/591; H01M 10/0587; H01M 50/103

(57) ABSTRACT

A secondary battery includes an electrode assembly, an accommodating case that accommodates the electrode assembly, and a support member disposed between the accommodating case and the electrode assembly, in which the support member includes a pair of support plates that support the electrode assembly, and a projecting portion that projects from the support plates toward an inner surface of the accommodating case and comes into contact with the inner surface, and the projecting portion includes a rib structure or a shape that bulges toward the inner surface.

### CROSS-REFERENCE TO RELATED APPLICATION

This application claims priority to Japanese Patent Application No. 2025-018891 filed on Feb. 7, 2025. The disclosure of the above-identified application, including the specification, drawings, and claims, is incorporated by reference herein in its entirety.

### BACKGROUND

### 1. Technical Field

The present disclosure relates to a secondary battery.

### 2. Description of Related Art

As a conventional secondary battery, Japanese Unexamined Patent Application Publication No. 2018-041596 (JP 2018-041596 A) discloses a configuration in which a resistance member is disposed between a peripheral face of an insulating film container encasing a wound electrode assembly and a battery case, to block a gap between the insulating film and the battery case, thereby restricting movement of fluid that is present in the gap.

### SUMMARY

The resistance member described in JP 2018-041596 A is intended to restrict the movement of the fluid, and there is a concern that when the secondary battery vibrates, the insulating film container will also vibrate, causing the wound electrode assembly to move. Also, when the electrode assembly is formed to be large in size in order to increase capacity thereof, suppressing movement of the electrode assembly becomes difficult.

The present disclosure has been made in consideration of the aforementioned problems, and an object of the present disclosure is to provide a secondary battery that can suppress movement of the electrode assembly.

A secondary battery according to the present disclosure includes an electrode assembly, an accommodating case that accommodates the electrode assembly, and a support member disposed between the accommodating case and the electrode assembly. The support member includes a pair of support plates that supports the electrode assembly, and a projecting portion that projects from the support plates toward an inner surface of the accommodating case and comes into contact with the inner surface. The projecting portion includes a rib structure or a shape that bulges toward the inner surface.

In the secondary battery based on the present disclosure, the electrode assembly may be a wound electrode assembly that is wound about a winding axis, and of which a pair of curved portions is situated at both ends in a width direction that is orthogonal to the winding axis. The support plates may be disposed on outer sides of the curved portions in the width direction.

In the secondary battery according to the present disclosure, the support member may include a plate connecting the support plates. The support plates and the plate may be integrally fashioned.

According to the present disclosure, a secondary battery that can suppress movement of the electrode assembly can be provided.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is an exploded perspective view of a secondary battery according to a first embodiment;

FIG. 2 is a schematic cross-sectional view of the secondary battery taken along line II-II in FIG. 1;

FIG. 3 is a schematic cross-sectional view of the secondary battery taken along line III-III in FIG. 1;

FIG. 4 is a schematic cross-sectional view illustrating a support member of the secondary battery according to a second embodiment; and

FIG. 5 is a schematic cross-sectional view illustrating a support member of the secondary battery according to a third embodiment.

### DETAILED DESCRIPTION OF EMBODIMENTS

Hereinafter, embodiments of the present disclosure will be described in detail with reference to the drawings. Note that in the following embodiments, the same or common portions are denoted by the same signs throughout the drawings, and description thereof will not be repeated.

### First Embodiment

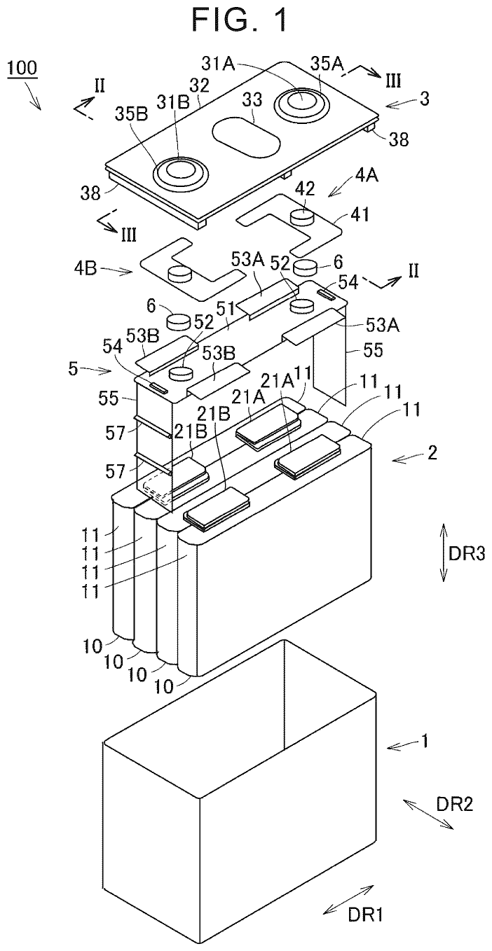

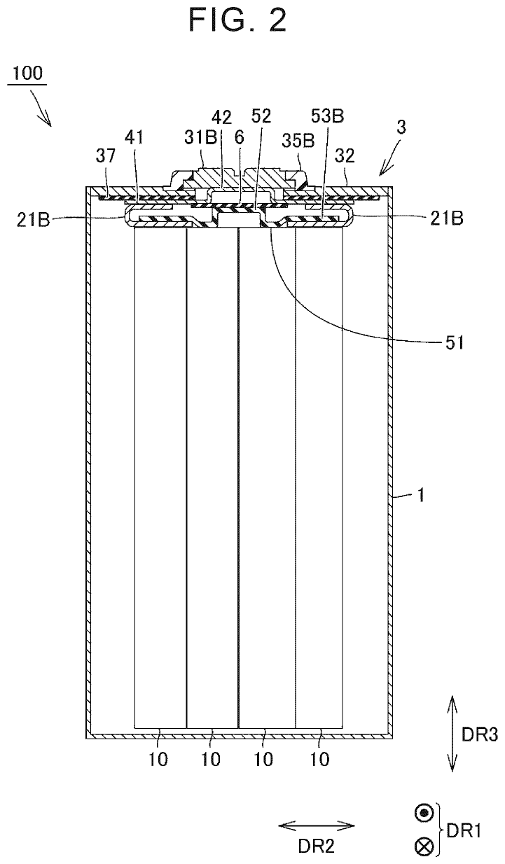

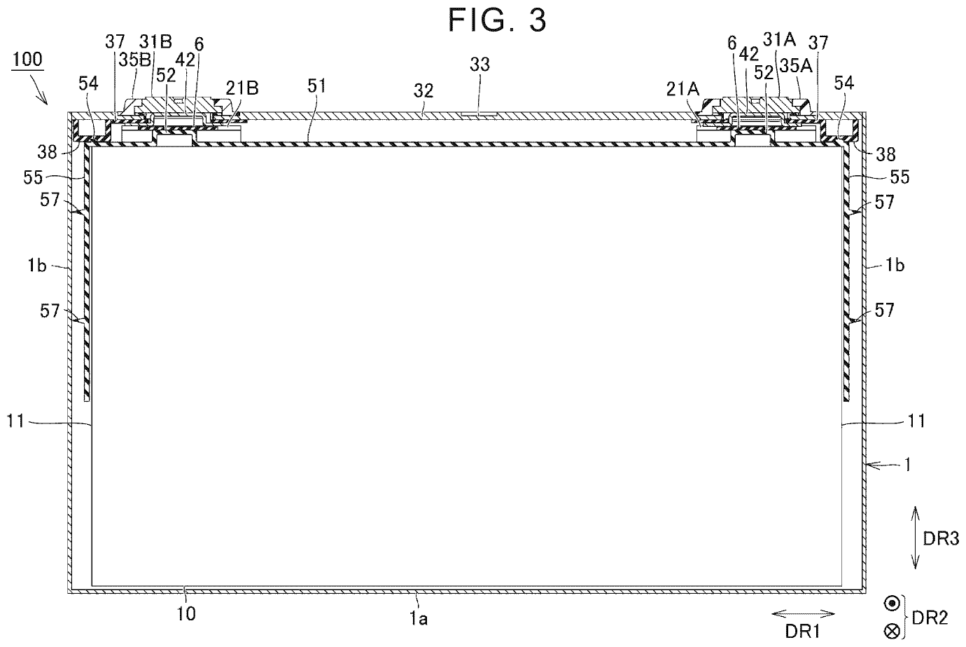

FIG. 1 is an exploded perspective view of a secondary battery according to a first embodiment. FIG. 2 is a schematic cross-sectional view of the secondary battery taken along line II-II in FIG. 1. FIG. 3 is a schematic cross-sectional view of the secondary battery taken along line III-III in FIG. 1.

A secondary battery 100 is a so-called prismatic battery. The secondary battery 100 is a battery that can be charged and discharged, such as a lithium-ion battery, a nickel metal hydride battery, or the like. The secondary battery 100 is used, as a cell included in a power storage module installed in an electrified vehicle, for example.

The secondary battery 100 includes a case body 1, an electrode assembly 2, a lid assembly 3, linking members 4A and 4B, a support member 5, and a plurality of insulating protection members 6.

The case body 1 has a generally box-like shape that opens upward. An opening portion of the case body 1 is closed off by the lid assembly 3. The case body 1 accommodates the electrode assembly 2, the linking members 4A and 4B, and the insulating protection members 6 therein.

The lid assembly 3 is disposed at an opening end of the case body 1. The lid assembly 3 includes a first external terminal 31A, a second external terminal 31B, a lid plate 32, fixing members 35A and 35B, and a plurality of engaged portions 38. The lid plate 32 has a plate-like shape. The lid plate 32 is fixed to the case body 1 by welding or the like, for example. The lid plate 32 and the case body 1 make up an accommodating case that accommodates a plurality of electrode assemblies 10 therein.

The lid plate 32 is provided with a pressure release valve 33. The pressure release valve 33 is provided so as to be capable of opening when internal pressure of the case body 1 reaches or exceeds a predetermined value.

The lid plate 32 is provided with the first external terminal 31A and the second external terminal 31B. The first external terminal 31A and the second external terminal 31B are disposed apart from each other in a first direction. A first direction DR1 is a direction orthogonal to winding axes of the electrode assemblies 10 that will be described later, and is parallel to a width direction of the electrode assemblies 10.

The first external terminal 31A is, for example, a cathode terminal. The first external terminal 31A is fixed to the lid plate 32 by the fixing member 35A. The fixing member 35A has an annular shape. The fixing member 35A is made of an insulating member, for example. The fixing member 35A is retained in a through hole provided in the lid plate 32.

The second external terminal 31B is, for example, an anode terminal. The second external terminal 31B is fixed to the lid plate 32 by the fixing member 35B. The fixing member 35B has an annular shape. The fixing member 35B is made of an insulating member, for example. The fixing member 35B is retained in a through hole provided in the lid plate 32.

Insulating members 37 and the engaged portions 38 are provided on an inner surface side of the lid plate 32. The insulating members 37 keep flat plate portions 41 of the linking members 4A and 4B from being electrically connected to the lid plate 32. The engaged portions 38 extend along a second direction DR2. The second direction DR2 is a direction orthogonal to the first direction DR1. The engaged portions 38 have shapes of blocks that are elongated. Engaging portions 54 of the support member 5, which will be described later, engage the engaged portions 38. Thus, the support member 5 is fixed to the lid plate 32.

The electrode assembly 2 includes multiple electrode assemblies 10. Each of the electrode assemblies 10 is, for example, a wound electrode assembly that is wound about a winding axis. The wound electrode assembly has a pair of curved portions 11 on both ends thereof in the width direction orthogonal to the winding axis.

Note that the winding axis is parallel to a third direction DR3. The third direction DR3 is a direction orthogonal to the first direction DR1 and the second direction DR2. In the present embodiment, the third direction DR3 is parallel to a vertical direction.

The wound electrode assembly is formed by winding a cathode member, an anode member, and a separator. The cathode member is coated with a cathode active material layer, and the anode member is coated with an anode active material layer.

Note that the electrode assemblies 10 are not restricted to being wound electrode assemblies, and may be laminates in which cathode members and anode members are alternately laminated in a state in which separators are interposed therebetween.

Each of the electrode assemblies 10 is provided with a plurality of first tabs 21A and a plurality of second tabs 21B. The first tabs 21A extend from the cathode members. The second tabs 21B extend from the anode members. No active material layer is provided on each of the first tabs 21A and the second tabs 21B.

Two electrode assemblies 10, arrayed side by side in the second direction DR2, make up one set of the electrode assemblies 10. Two of this one set of electrode assemblies 10 are arrayed side by side in the second direction DR2. In each set of electrode assemblies 10, the first tabs 21A and the second tabs 21B are respectively bundled together.

The first tabs 21A that are bundled and the second tabs 21B that are bundled are bent in a substantially letter-U shape so as to extend toward the outside in the second direction DR2, and then head toward the inside in the second direction.

The first tabs 21A are connected to the linking member 4A. Specifically, the first tabs 21A are connected to a rear face side of the flat plate portion 41 of the linking member 4A. The second tabs 21B are connected to the linking member 4B. Specifically, the second tabs 21B are connected to a rear face side of the flat plate portion 41 of the linking member 4B. The rear face of the flat plate portion 41 is a principal face facing the side of the electrode assemblies 10.

The linking members 4A and 4B are made of conductive members. The linking members 4A and 4B each have the flat plate portion 41 and a protruding portion 42. Each of the flat plate portions 41 has a substantially letter-U shape opening to the inner side in the first direction DR1. The protruding portions 42 project from the flat plate portions 41 toward one side in the third direction DR3. That is to say, the protruding portions 42 project from the flat plate portions 41 toward the lid plate 32 side.

The protruding portion 42 of the linking member 4A is connected to the first external terminal 31A. The protruding portion 42 of the linking member 4B is connected to the second external terminal 31B.

The support member 5 is disposed between the electrode assemblies 10 and the accommodating case. The support member 5 supports the electrode assembly 2. The support member 5 has insulating properties, and keeps the electrode assembly 2 from coming into contact with the inner surface of the accommodating case and causing short-circuiting. A detailed structure of the support member 5 will be described later.

The insulating protection members 6 are disposed between a plate 51 of the support member 5 and the protruding portions 42 of each of the linking members 4A and 4B. Even in a situation in which metal foreign objects or the like enter recessed portions situated on the inner sides of the protruding portions 42 in an assembly process of the secondary battery 100, the insulating protection members 6 are disposed thereat, whereby the metal foreign objects or the like can be suppressed from moving from the recessed portions toward the electrode assembly 2 side. This can suppress short-circuiting caused by foreign objects from occurring in the electrode assembly 2. The insulating protection members 6 are situated downward from the protruding portions 42 of each of the linking members 4A and 4B, and are clamped between the flat plate portions 41 of each of the linking members 4A and 4B, and loading portions 52 of the support member 5, which will be described later. Note that the insulating protection members 6 may be disposed in recesses on the inner sides of the protruding portions 42.

A foam material, a rubber material, a glue-like material that is applied and solidified, or the like, having insulating properties, can be employed as appropriate for the insulating protection members 6.

The support member 5 includes the plate 51, the loading portions 52, overhang portions 53A and 53B, a pair of the engaging portions 54, a pair of support plates 55, and projecting portions 57.

The plate 51 extends along the first direction DR1. The plate 51 faces upper faces of the electrode assemblies 10. The plate 51 is made of a resin member that has insulating properties, for example.

The plate 51 is provided with the loading portions 52 at positions corresponding to the protruding portions 42 of the linking members 4A and 4B. Each of the loading portions 52 projects from the plate 51 toward the lid plate 32 side. The insulating protection members 6 are placed on the loading portions 52. Each of the loading portions 52 is also made of a resin member that has insulating properties.

The plate 51 is also provided with the overhang portions 53A and 53B that overhang outward in the second direction DR2. The overhang portions 53A and 53B extend from the plate 51 toward one side in the third direction (lid plate 32 side) and then overhang outward in the second direction DR2.

The overhang portions 53A and 53B are made of a resin member that has insulating properties. The overhang portions 53A are disposed at positions corresponding to the first tabs 21A bent in letter-U shapes, and project into inner regions of the letter-U shapes of the first tabs 21A. The overhang portions 53B are disposed at positions corresponding to the second tabs 21B bent in letter-U shapes, and project into inner regions of the letter-U shapes of the second tabs 21B. This enables the first tabs 21A and the second tabs 21B to be kept from being pressed toward the electrode assembly 2 side, thereby keeping the electrode assembly 10 from short-circuiting.

The engaging portions 54 are provided at both end portions of the plate 51 in the first direction DR1. The engaging portions 54 project toward the lid plate 32 side. The engaging portions 54 engage the engaged portions 38 described above. This allows the support member 5 to be disposed in the accommodating case in a stable manner.

The support plates 55 support multiple electrode assemblies 10. The support plates 55 are situated on outer sides from the curved portions 11 in the width direction of the electrode assemblies 10. The support plates 55 are disposed between the electrode assemblies 10 and a pair of side wall portions 1b of the case body 1.

The support plates 55 clamp the electrode assemblies 10 in the width direction. The support plates 55 are provided on both ends of the plate 51 in the first direction DR1. The support plates 55 extend toward the other side in the third direction DR3. The support plates 55 extend toward a bottom wall portion 1a of the case body 1. The support plates 55 are made of a resin member that has insulating properties.

The projecting portions 57 project from each of the support plates 55 toward the inner surfaces of the accommodating case, and are in contact with the inner surfaces. Specifically, the projecting portions 57 project from the support plate 55 situated on one side in the first direction toward an inner surface of the side wall portion 1b located on one side in the first direction, and are in contact with the inner surface thereof. The projecting portions 57 project from the support plate 55 situated on the other side in the first direction DR1 toward the inner surface of the side wall portion 1b located on other side in the first direction, and are in contact with the inner surface thereof. The projecting portions 57 have rib structures. That is to say, each of the support plates 55 is provided with a plurality of ribs, and the ribs make up the projecting portions 57. The projecting portions 57 may be formed integrally with the support plate 55.

As described above, in the present embodiment, the projecting portions 57 having rib structures provided on the support plates 55 disposed on both outer sides of the electrode assemblies 10 in the first direction DR1 come into contact with the inner surfaces of the side wall portions 1b, thereby pressing the support plates 55 toward the inner side in the first direction DR1. Thus, the electrode assemblies 10 are clamped between the support plates 55, and movement of the electrode assemblies 10 can be suppressed.

Also, the support plates 55 support the electrode assemblies 10 in a state of being disposed on the outer sides of the curved portions 11 in the width direction. The curved portions 11 are parts that are prone to vibration, and accordingly clamping the curved portions 11 between the support plates 55 enables movement of the electrode assemblies 10 to be effectively suppressed.

Note that the plate 51 and the support plates 55 may be integrally formed. That is to say, the plate 51 and the support plates 55 may be integrally formed by a resin member. Moreover, the projecting portions 57 may also be formed integrally with the plate 51 and the support plates 55.

The plate 51 connects the support plates 55, whereby positions of the support plates 55 can be stabilized. Further, the plate 51 allows the electrode assemblies 10 to move toward the lid plate 32 side. In addition, integrally forming the plate 51 and the support plates 55 allows the configuration of the support member 5 to be simplified.

### Second Embodiment

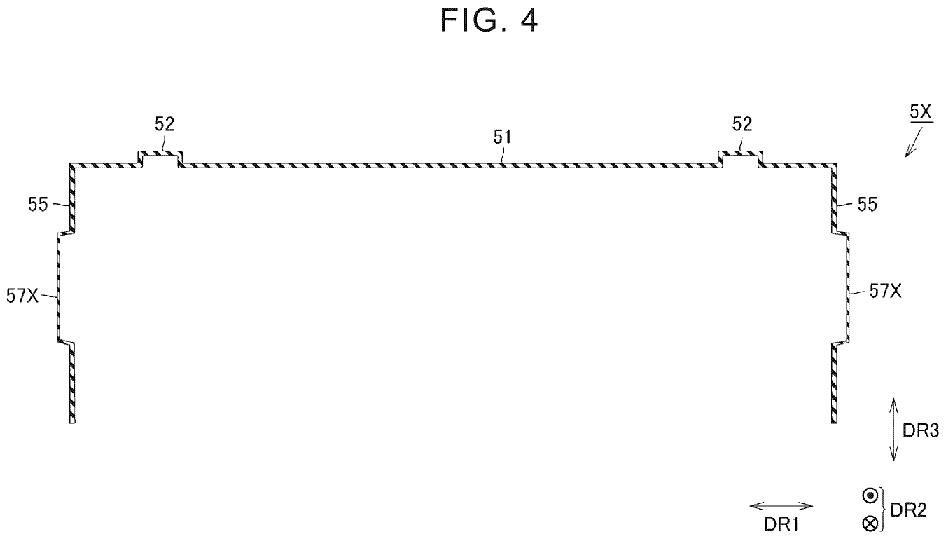

FIG. 4 is a schematic cross-sectional view illustrating a support member of the secondary battery according to a second embodiment. A support member 5X according to the second embodiment will be described with reference to FIG. 4.

The support member 5X can be employed in the secondary battery 100 in place of the support member 5 according to the first embodiment. The support member 5X differs from the support member 5 according to the first embodiment with respect to the configuration of projecting portions 57X. Other configurations are substantially the same.

The projecting portions 57X have shapes that bulge out toward the inner surface of the accommodating case. A projecting portion 57X bulges out from the support plate 55 situated on one side in the first direction toward the inner surface of the side wall portion 1b situated on one side in the first direction. A projecting portion 57X bulges out from the support plate 55 situated on the other side in the first direction DR1 toward the inner surface of the side wall portion 1b situated on the other side in the first direction.

The portions of the projecting portions 57X that come into contact with the inner surfaces are provided to be substantially flat. This enables the projecting portions 57X to come into contact with the inner surfaces over a wide area. As a result, the electrode assemblies 10 can be supported more stably.

### Third Embodiment

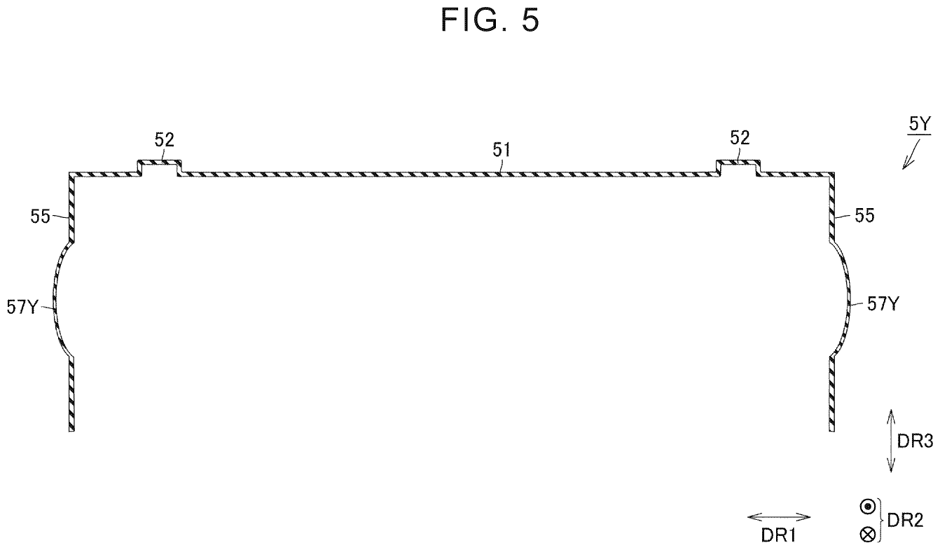

FIG. 5 is a schematic cross-sectional view illustrating a support member of the secondary battery according to a third embodiment. A support member 5Y according to the third embodiment will be described with reference to FIG. 5.

The support member 5Y can be employed in the secondary battery 100 in place of the support member 5 according to the first embodiment. The support member 5Y differs from the support member 5 according to the first embodiment with respect to the configuration of projecting portions 57Y. Other configurations are substantially the same.

The projecting portions 57Y have shapes that bulge out toward the inner surface of the accommodating case. A projecting portion 57Y bulges out from the support plate 55 situated on one side in the first direction toward the inner surface of the side wall portion 1b situated on one side in the first direction. A projecting portion 57Y bulges out from the support plate 55 situated on the other side in the first direction DR1 toward the inner surface of the side wall portion 1b situated on the other side in the first direction.

The portions of the projecting portions 57Y that come into contact with the inner surfaces are formed in a substantially arcuate shape or an elliptical arcuate shape. This allows the support member 5Y to flexibly accommodate manufacturing error and so forth in the inner dimensions of the accommodating case. Even when there is dimensional error or the like, the projecting portions 57Y can exhibit flexing deformation and come into contact with the inner surfaces of the accommodating case.

The embodiments disclosed herein should be considered to be exemplary in all respects and not restrictive. The scope of the present disclosure is set forth in the claims, and includes all modifications within the meaning and scope equivalent to the claims.

What is claimed is:

1. A secondary battery comprising:
an electrode assembly;
an accommodating case that accommodates the electrode assembly; and
a support member disposed between the accommodating case and the electrode assembly, wherein
the support member includes a pair of support plates that supports the electrode assembly, and a projecting portion that projects from the support plates toward an inner surface of the accommodating case and comes into contact with the inner surface, and
the projecting portion includes a rib structure or a shape that bulges toward the inner surface.

2. The secondary battery according to claim 1, wherein
the electrode assembly is a wound electrode assembly that is wound about a winding axis, and of which a pair of curved portions is situated at both ends in a width direction that is orthogonal to the winding axis, and
the support plates are disposed on outer sides of the curved portions in the width direction.

3. The secondary battery according to claim 2, wherein
the support member includes a plate connecting the support plates, and
the support plates and the plate are integrally fashioned.
